(19) United States
(12) Patent Application Publication
(10) Pub. No.: US 2024/0341240 A1
(43) Pub. Date: Oct. 17, 2024

(54) NET FOR BALING PRESSES

(71) Applicant: RKW Agri GmbH & Co. KG, Mannheim (DE)

(72) Inventors: Christian KOLASS, Brensbach (DE); Andreas WIBIRAL, Michelstadt (DE); Peter WALTHER, Michelstadt (DE); Lutz KAUFMANN, Michelstadt (DE); Holger VOIT, Luetzelbach (DE)

(73) Assignee: RKW Agri GmbH & Co. KG, Mannheim (DE)

(21) Appl. No.: 18/683,305

(22) PCT Filed: Aug. 8, 2022
(86) PCT No.: PCT/EP2022/072189

§ 371 Date: Feb. 13, 2024

(30) Foreign Application Priority Data
Sep. 21, 2021 (DE) 102021124311.4

(51) Int. Cl. A01F 15/07; D04B 21/12

(52) U.S. Cl. CPC A01F 15/071; D04B 21/12; A01F 2015/0745

(57) ABSTRACT

A net for baling presses with basic weaves consisting of meshes formed from threads and connected to a weft. The basic weaves are formed as fringes and the net has less than 49 fringes. The net has a tensile strength of more than 2300 N, preferably more than 2550 N, in particular more than 2800 N.

### CROSS-REFERENCE TO RELATED APPLICATIONS

This application is a 371 National Phase of PCT/EP2022/072189, filed Aug. 8, 2022, which claims priority from German Patent Application No. 10 2021 124 311.4, filed Sep. 21, 2021, both of which are incorporated herein by reference as if fully set forth.

### TECHNICAL FIELD

The invention relates to a net for balers with basic weaves consisting of meshes formed with threads which are connected with a weft.

### BACKGROUND

Nets are widely used as a material for air-permeable packaging of loose goods such as hay, straw, vegetables, raw cotton, logs, waste or other plant parts. Nets for packing loose goods are preferably produced by raschel machines. Such raschel machines are manufactured, for example, by Textilmaschinenfabrik Karl Mayer GmbH, Frankfurt, Germany.

The packaging unit bale is usually produced by balers, preferably round balers. In this process, the hay, straw or grass silage is rolled up with the help of a drawn baler and preferably formed into cylindrical bales. This can be done in a baler, for example, either by rubber-covered belts or by steel rollers. When the bale has reached a certain size, it is tied with a round bale net before the rear part of the baler opens and the bale can roll out. The bales usually have a diameter of 120 to 180 cm and are about 120 cm wide. The weight is between 200 kg for loosely baled straw and 1000 kg for grass silage with a dry matter content of only 20%.

Nets for round bales are wide-meshed nets made of polymer material, preferably polyethylene, preferably high density polyethylene (HDPE). The fine and stable tapes are first cut from HDPE film, which is then knitted into the actual net for balers. Nets for balers are wound on rolls with a large number of running metres. This makes them high-yielding and requires only a few roll changes during pressing.

The way the threads are interlaced in a knitted fabric, for example a net, is called a weave. The weaves allow the threads in the net to stay together permanently. The weave is constantly repeated over the entire surface of the net. Basic weaves include meshes and lappings. The mesh weave determines the type of thread interlacing in knitted fabrics. The mesh is the connection of two knitted loops of thread to form the smallest, stable unit of a knitted fabric.

According to the prior art, 1-inch nets are used for air-permeable packaging of loose goods. DE 3227 160 C2 describes a roll bale made of agricultural stalk material with a circumferential, form-fixing casing web made of fabric, which has overlapping end pieces that adhere to each other. The fabric of the casing web consists of an essentially inelastic net in the circumferential direction, which additionally adheres with its overlapping area to the stalk material passing through without additional fixings such as welding, stapling or gluing.

In EP 2 683 863 B2, a raschel machine is disclosed comprising a stretching device for stretching the length of a mesh made of a weft thread connecting two rows of meshes of warp threads during the production of a net by controlling the working path of the stitch during the drawing of the rows of meshes in a machine direction, the stretching device comprising an elongated flexible object having a surface for positioning the stitch during the drawing of the rows of meshes and an abutment portion, for pressing against an abutment member of the raschel machine during reciprocating movement of the object, and a mounting means for mounting a drive means for producing the reciprocating movement, the stretching device being configured for moving the surface of the object towards the stitch positioned on the surface during the reciprocating movement. In this regard, a flexible projection is disposed on the surface of the object to prevent movement of the stitch positioned on the surface during the reciprocating motion and pulling of the rows of meshes away from the surface and to release the stitch acting on the projection.

EP 0 919 655 B2 discloses a raschel-knitted net comprising longitudinal polyolefin tapes and transverse polyolefin tapes knitted with the longitudinal polyolefin tapes on a machine to form a knitted net, wherein two longitudinal polyolefin tapes form the legs of a triangle. When the net is rolled up, at least one of its polyolefin transverse tapes has an actual length that is more than 110% of a calculated length for the knitted net.

DE 10 2015 119 867 A1 describes a raschel machine comprising a plurality of first punching needles arranged along a first direction for guiding warp threads, a plurality of second punching needles arranged along the first direction for guiding weft threads, and a plurality of needles arranged along the first direction for forming knitted loops of threads, thereby forming the warp threads. The first punching needles are held by a first needle bar, the second punching needles are held by a second needle bar, and the second needle bar is reciprocated between each two adjacent first punching needles. The distance between the adjacent first punching needles is greater than 25.4 mm.

DE 10 2015 119 867 A1 also discloses a 2-inch net. The increased distance between the adjacent rows of meshes promises a great savings potential with regard to the polymer material used. However, the individual threads are many times thicker, which means that the polymer material savings cannot be achieved.

### SUMMARY

The object of the invention is to provide a net for balers which contributes to saving resources by using as little polymer material as possible and at the same time has a high tear strength. At the same time, the net should be particularly stable and tear-resistant, fulfil the required mechanical properties of the intended use and ensure reliable packaging of loose goods. Furthermore, the net should be recyclable.

According to the invention, this object is achieved by a net for balers. Preferred variants can be found in the description, the embodiment example, the claims, and the drawing.

According to the invention, the basic weaves of the net are formed as fringes. The net has less than 49 fringes at a width of 1.23 m, which saves polymer material compared to the prior art due to the lower number of fringes. Furthermore, the net has a tear strength of more than 2300 N, preferably more than 2550 N, in particular more than 2800 N. Despite using less polymer material, the net exceeds the tear strength of known high-performance nets. This is realised in particular by the special formulation and the special production technique.

The basic weave used to knit the net for balers is the mesh in the form of a fringe, in particular the open fringe, in combination with the weft weave element.

When creating a fringe, the guide bar of a raschel machine always puts the same thread around the same needle. When knitting fringes, only stitch wales are produced that do not form a continuous surface. For this reason, the fringe is knitted in combination with the binding element weft, which creates the lateral connection between the stitch wales. For the weft, a separate guide bar is used in the raschel machine.

To reduce the usage of polymer material, the net has less than 38 fringes, preferably less than 36 fringes, in particular less than 34 fringes. For sufficient stability and satisfactory tear strength, the net has more than 28 fringes, preferably more than 30 fringes, in particular more than 32 fringes.

In a particularly favorable variant, the net has 33 fringes and corresponds to a 1.5-inch net, related to the standardised standard width of 1.23 m. Due to the special recipe and the sophisticated knitting technology, the 1.5 inch net shows an optimum in terms of material savings with the best mechanical properties at the same time.

The mechanical properties include, for example, the elongation at break of the net. The net has an elongation at break of more than 16%, preferably more than 18%, in particular more than 20% and/or less than 28%, preferably less than 26%, in particular less than 24%.

In addition, the fringes are knitted from threads with special properties so that the net with a width of 123 cm has a specific weight of more than 7 g/rm, preferably more than 8 g/rm, in particular more than 9 g/rm and/or is less than 13 g/rm, preferably less than 12 g/rm, in particular less than 11 g/rm.

Due to the special formulation of various polyolefins in combination with a sophisticated film production technique, the knitted net has a tensile strength of more than 40 cN/tex, preferably more than 50 cN/tex, in particular more than 60 cN/tex according to DIN EN ISO 527-3. In textile technology, the unit tex stands for 1 g/1000 m.

The mesh density refers to the number of meshes per centimetre and is thus a measure of the density of the knitted fabric. The fringes of the net for balers are particularly tear-resistant, which is due to the special formulation and the optimum mesh density. In this case, the fringes have a mesh density of more than 0.6 meshes/cm, preferably more than 0.7 meshes/cm, in particular more than 0.8 meshes/cm and/or less than 1.2 meshes/cm, preferably less than 1.1 meshes/cm, in particular less than 1.0 meshes/cm.

The raschel machine's fringing creates fringes of triple-knitted threads, which contributes to the net's special tear strength.

The weft is created by moving the weft thread between two needles while the net being knitted moves longitudinally in the knitting machine. Due to the two directional movements, the weft forms the legs of a triangle, while the fringe forms a triangular base. The tension of the weft can be adjusted to form a so-called weft reserve.

Preferably, the net has a weft reserve of more than 112%, preferably more than 114%, in particular more than 116% and/or less than 124%, preferably less than 122%, in particular less than 120%.

In a particularly favourable variant of the invention, the weft reserve is exactly 118%.

In an advantageous variant of the invention, adjacent fringes are connected with a weft thread in a zigzag pattern, wherein more than every 3rd mesh, preferably more than every 4th mesh, in particular more than every 5th mesh of a fringe is knitted with the weft thread and/or wherein less than every 9th mesh, preferably less than every 8th mesh, in particular less than every 7th mesh is knitted with the weft thread.

In a particularly favorable variant of the invention, every 6th mesh is knitted with a weft thread.

The net for balers according to the invention has an enormous tear strength, although the polymer material threads are made particularly thin to save material. Here, the thickness of the threads is more than 15 μm, preferably more than 30 μm, in particular more than 45 μm and/or less than 85 μm, preferably less than 70 μm, in particular less than 55 μm.

In a particularly favorable variant, the thickness of the thread is 50 μm.

The weft provides the transverse stability of the net for balers. In order to achieve the highest possible polymer material savings for resource conservation, the thickness of the weft is more than 5 μm, preferably more than 10 μm, in particular more than 15 μm and/or less than 50 μm, preferably less than 45 μm, in particular less than 40 μm.

All these described characteristics establish a net for balers that has an enormous tear strength, although the polymer material content is significantly reduced compared to 1-inch nets and thus takes into account the endeavour to conserve resources. Only this special combination of features results in a unique net that at the same time still conserves the use of polymer material.

These special properties are achieved by the selection of special input materials and by the sophisticated film technology. In this context, the threads of the polymer material film for the fringes preferably have a polyethylene component, preferably an HDPE, the proportion of the polyethylene component being more than 50% by weight, preferably more than 60% by weight, in particular more than 70% by weight and/or less than 85% by weight, preferably more than 80% by weight, in particular more than 75% by weight.

Furthermore, the favorable features of the net for balers net are produced by filaments comprising a polypropylene component, preferably a PP, preferably a random copolymer, wherein the proportion of the polypropylene component is more than 10% by weight, preferably more than 15% by weight, in particular more than 20% by weight and/or less than 40% by weight, preferably more than 35% by weight, in particular more than 30% by weight.

The threads of the weft are produced by a film comprising a polyethylene component, preferably an HDPE, the proportion of the polyethylene component being more than 80% by weight, preferably more than 90% by weight, in particular more than 95% by weight.

The polymer components mentioned are preferably first extruded by blow extrusion to form a primary film for the fringe threads. Preferably, the film is cut into approx. 5 mm wide tapes, which have a thickness of approx. 100-140 μm, for example. The tapes are stretched over a heating comb at approx. 90-120° C. with a stretching ratio of 1:4 to 1:8.

The polymer components for the threads of the weft are preferably extruded by blow extrusion into a film that has a thickness of 70-90 μm. This film is preferably cut into tapes with a width of approx. 2.4-2.7 mm. The tapes for the weft are stretched over a heating comb at approx. 90-120° C. with a stretching ratio of 1:4 to 1:8.

Due to the special selection of the polymer components, the basis for recycling is created at the same time. The unmixed polyolefin net can be fed into the recycling loop after use.

In a particularly favorable variant of the invention, the number of weft threads is more than 20, preferably more than 25, in particular more than 30 and/or less than 50, preferably less than 40, in particular less than 35.

In an advantageous variant of the invention, the distance between adjacent fringes is more than 25.4 mm and less than 50.8 mm, preferably the distance is more than 31.75 mm and less than 44.45 mm, in particular the distance is exactly 38.1 mm.

In order to withstand the effects of the sun's rays beyond harvesting, the threads of the fringe and/or the threads of the weft have a UV-protection component, the proportion of the UV-protection component in the polymer blend being more than 1% by weight, preferably more than 2% by weight, in particular more than 3% by weight and/or less than 7% by weight, preferably more than 6% by weight, in particular more than 5% by weight.

### BRIEF DESCRIPTION OF THE DRAWINGS

Further advantages and features of the invention can be seen from the description of an example of an embodiment based on a drawing and from the drawing itself. Thereby shows:

FIG. 1 a detailed representation of a net for balers.

### DETAILED DESCRIPTION

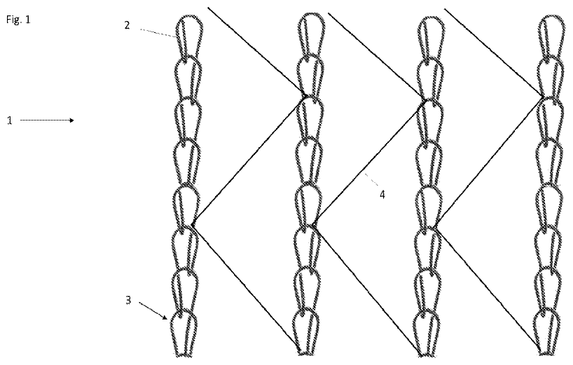

FIG. 1 shows a detailed illustration of a net for balers. In this embodiment, a 1.5 inch net 1 is shown which comprises 33 fringes 3. The meshes are in the form of open fringes, which are knitted from threads 2. The triple-knitted fringes have a mesh density of 0.9 meshes/cm. The threads 2 have a thickness of 49 μm. The net 1 has a specific weight of 10 g/rm and a tensile strength of 55 cN/tex. Adjacent fringes 3 are each knitted with a weft 4, resulting in the net 1 as a flat structure. A weft 4 is inserted into every sixth mesh of a fringe 3. The symmetrical weft knitted from fringe 3 to fringe 3 creates a zigzag pattern. The thus knitted bale net has a tear strength of more than 2850 N and an elongation at break of 22%.

1. A net for balers, comprising:
at least one basic weave comprising meshes formed by threads connected with a weft,
wherein the at least one basic weave is formed by fringes,
there are less than 49 fringes,
and the net has a tear strength of more than 2300 N.

2. The net according to claim 1, wherein the net has a width of 123 cm.

3. The net according to claim 1, wherein the net has less than 38 fringes and more than 32 fringes.

4. The net according to claim 1, wherein the net has an elongation at break of more than 16% and less than 24%.

5. The net according to claim 1, wherein the net has a specific weight of more than 7 g/rm and less than 11 g/rm at a width of 1.23 m.

6. The net according to claim 1, wherein the net has a tensile strength of more than 40 cN/tex according to DIN EN ISO 527-3.

7. The net according to claim 1, wherein the fringes have more than 0.6 meshes/cm and less than 1.0 mesh/cm.

8. The net according to claim 1, wherein the fringes are formed from triple-knitted threads.

9. The net according to claim 1, wherein the net has a weft reserve of more than 112% and less than 120%.

10. The net according to claim 1, wherein adjacent ones of the fringes are connected to the weft in a zigzag pattern, and more than every 3^{rd} one of the meshes and less than every 7^{th} one of the meshes of each said fringe is knitted with the weft.

11. The net according to claim 1, wherein a thickness of the threads is at least one of more than 15 μm or less than 85 μm.

12. The net according to claim 1, wherein a thickness of the weft is at least one of more than 5 μm or less than 50 μm.

13. The net according to claim 1, wherein the threads comprise a polyethylene component, a proportion of the polyethylene component being at least one of more than 50% by weight or less than 85% by weight.

14. The net according to claim 1, wherein the threads comprise a polypropylene component, a proportion of the polypropylene component being at least one of more than 10% by weight or less than 40% by weight.

15. The net according to claim 1, wherein the weft comprises a polyethylene component, a proportion of the polyethylene component being more than 80% by weight.
